(19) United States
(12) Patent Application Publication
(10) Pub. No.: US 2025/0093746 A1
(43) Pub. Date: Mar. 20, 2025

(54) IMAGING DEVICE

(71) Applicant: NIDEC PRECISION CORPORATION, Tokyo (JP)

(72) Inventor: Yuusuke SUZUKI, Tokyo (JP)

(21) Appl. No.: 18/829,290

(22) Filed: Sep. 10, 2024

(30) Foreign Application Priority Data
Sep. 15, 2023 (JP) 2023-149981

(51) Int. Cl. G03B 11/04

(52) U.S. Cl. CPC G03B 11/043

(57) ABSTRACT

An imaging device includes an imaging element, a lens that guides subject light traveling through a first opening to the imaging element, a blade between the first opening and the lens and at a first position or at a second position, an actuator that moves the blade in a first direction intersecting with an optical axis of the lens, an auxiliary opening outside a viewing range of the lens to allow the subject light to travel through, and a controller that controls driving of the actuator to move the blade at the first position to the second position based on a change in an output from the imaging element receiving diffused light traveling through the auxiliary opening and reflected from inside a housing when the blade is at the first position.

### RELATED APPLICATIONS

The present application claims priority to Japanese Application Number 2023-149981, filed Sep. 15, 2023, the disclosure of which is hereby incorporated by reference herein in its entirety.

### BACKGROUND

### Technical Field

The present invention relates to an imaging device.

### DESCRIPTION OF THE BACKGROUND

Surveillance cameras are installed at various places such as nursing care facilities, hospitals, factories, and stores for crime and disaster prevention. Such surveillance cameras, which are imaging devices, are to be operated with privacy protection of individuals as subjects to be photographed. For privacy protection, a surveillance camera includes a light shield that covers a lens as appropriate.

Patent Literature 1 describes an assembly that is movable relative to a stationary member that is an imager to function as a shutter.

### CITATION LIST

### PATENT LITERATURE

Patent Literature 1: U.S. Patent Application Publication No. 2020/0249415

### BRIEF SUMMARY

The camera described in Patent Literature 1 can capture images with the imager after moving the shutter from a closed state to an open state. However, to detect the timing to open the shutter, an external trigger may be input when the shutter is closed, or a sensor for detecting the external environment of the camera may be installed. This complicates the structure of the camera.

An imaging device according to an aspect of the present invention includes an imaging element that receives subject light, an optical member that guides the subject light traveling through a first opening in a housing to the imaging element, a light shield between the first opening and the optical member and at a first position to restrict the subject light from entering the imaging element or at a second position to allow the subject light to enter the imaging element, a drive that moves the light shield in a first direction intersecting with an optical axis of the optical member to cause the light shield to be at the first position or at the second position, an auxiliary opening outside a viewing range of the optical member to allow the subject light to travel through, and a controller that controls driving of the drive to move the light shield at the first position to the second position based on a change in an output from the imaging element receiving diffused light traveling through the auxiliary opening and reflected from inside the housing when the light shield is at the first position.

The imaging device according to the above aspect of the present invention has a simple structure to detect the external environment of the imaging device and control the movement of the light shield.

### BRIEF DESCRIPTION OF DRAWINGS

FIG. 1A is an external view of an imaging device according to a first embodiment in a closed state.

FIG. 1B is an external view of the imaging device in an open state.

FIG. 2 is an exploded perspective view of the imaging device in the closed state.

FIG. 3A is a cross-sectional view of the imaging device taken along line A-A in FIG. 1A.

FIG. 3B is a partially enlarged cross-sectional view of region R shown in FIG. 3A.

FIG. 4A is a schematic diagram describing an example predetermined gesture performed by a user.

FIG. 4B is a schematic diagram describing an example predetermined gesture performed by the user.

FIG. 5 is a flowchart of a gesture detection process performed by a controller in the first embodiment.

FIG. 6A is an internal perspective view of the imaging device in the open state.

FIG. 6B is an internal perspective view of the imaging device in the closed state.

FIG. 7 is an external view of an imaging device according to a second embodiment in a closed state.

FIG. 8 is an exploded perspective view of the imaging device according to the second embodiment in the closed state.

FIG. 9A is a diagram describing an orientation of the imaging device and a predetermined gesture performed by the user.

FIG. 9B is a diagram describing an orientation of the imaging device and a predetermined gesture performed by the user.

FIG. 10 is a flowchart of a gesture detection process performed by a controller in the second embodiment.

FIG. 11A is an external view of an imaging device according to a first modification.

FIG. 11B is an external view of an imaging device according to a second modification.

### DETAILED DESCRIPTION

An imaging device according to one or more embodiments of the present invention will now be described in detail with reference to the drawings.

The imaging device may have any use and may be installed at, for example, a hospital, a nursing care facility, a factory, and a store as a surveillance camera or as a monitoring camera. The imaging device is switchable between an imaging state and an imaging-disabled state. More specifically, the imaging device can switch between a closed state in which light cannot enter an imaging optical system and an open state in which light can enter the imaging optical system. Once the imaging device switches to the imaging-disabled state (closed state), a person being imaged can recognize that the imaging device has been switched to the imaging-disabled state. The imaging device according to the present embodiment is automatically switchable from the imaging-disabled state to the imaging state upon detecting a predetermined gesture performed by the user.

First Embodiment

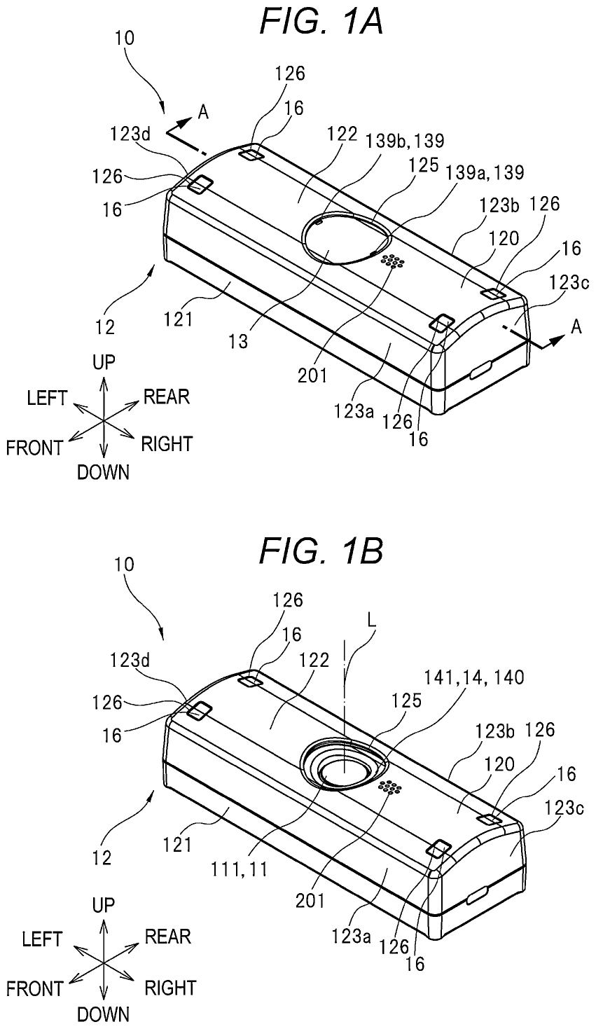

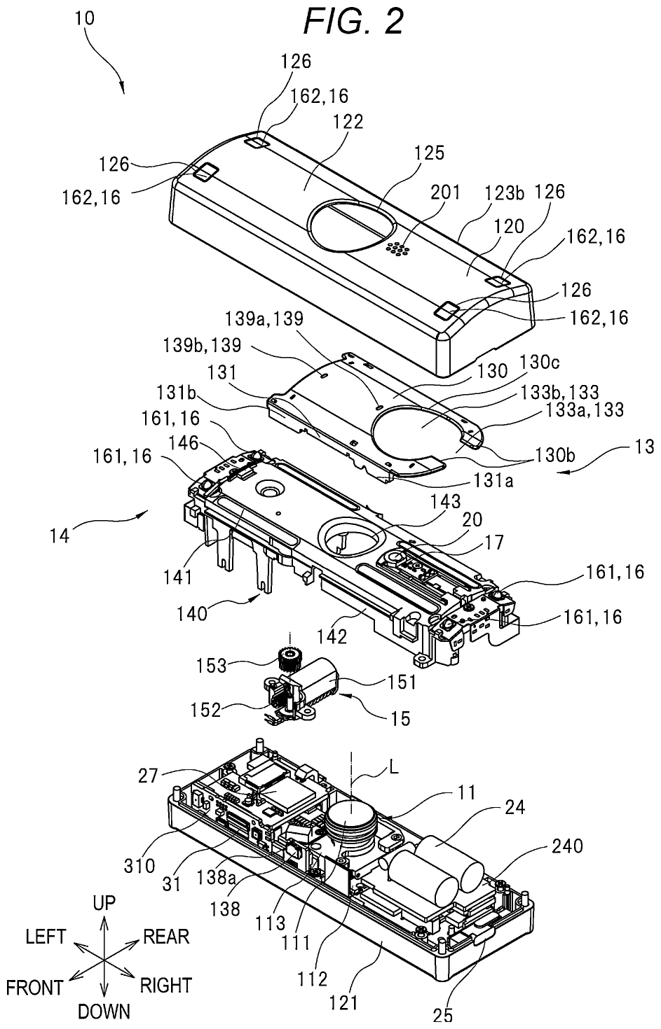

FIGS. 1A and 1B are each an external view of an imaging device 10 according to a first embodiment. FIG. 1A shows the imaging device 10 in a closed state. FIG. 1B shows the imaging device 10 in an open state. FIG. 2 is an exploded perspective view of the imaging device 10 in the closed state shown in FIG. 1A.

### Overall Structure of Imaging Device 10

The imaging device 10 is switchable from the closed state (FIG. 1A) to the open state (FIG. 1B). The imaging device 10 is switchable from the open state (FIG. 1B) to the closed state (FIG. 1A). As shown in FIGS. 1A to 2, the imaging device 10 includes a camera module 11, a housing (outer case) 12, a blade 13, a blade driver 14, illuminators 16, an illuminometer 17, a connector 25, an antenna 27, a controller 31, and a position sensor 138.

### Housing 12

The housing 12 includes a front case 120 and a rear case 121. The front case 120 includes a rectangular or substantially rectangular top plate 122 and sidewall plates 123a, 123b, 123c, and 123d that adjoin the sides of the top plate 122. The top plate 122 and the sidewall plates 123a, 123b, 123c, and 123d are integrally formed from a synthetic resin. The sidewall plate 123a adjoins one long side of the top plate 122. The sidewall plate 123b adjoins the other long side of the top plate 122. The sidewall plate 123c adjoins one short side of the top plate 122. The sidewall plate 123d adjoins the other short side of the top plate 122.

Hereafter, the direction in which the front case 120 in the housing 12 is located may be referred to as being upward, the direction in which the rear case 121 is located as being downward, the direction in which the sidewall plate 123a is located as being frontward, the direction in which the sidewall plate 123b is located as being rearward, the direction in which the sidewall plate 123c is located as being rightward, and the direction in which the sidewall plate 123d is located as being leftward. The lateral direction may be referred to as a first direction. The front-rear direction may be referred to as a second direction. The first direction intersects with an optical axis L of a lens 111 in the camera module 11 (described later). The second direction intersects with the first direction and the optical axis L.

The top plate 122 of the front case 120 has a circular first opening 125 connecting the inside and the outside of the housing 12. In other words, the first opening 125 is a through-hole in the top plate 122. Light (subject light) reflected from an imaging target (subject) travels through the first opening 125 into the housing 12 and enters the imaging optical system.

The top plate 122 of the front case 120 has illumination openings 126 at positions corresponding to the positions of the illuminators 16 (described later). In other words, the illumination openings 126 are also through-holes in the top plate 122. Illumination light emitted from the illuminators 16 travels through the illumination openings 126 to illuminate the imaging target (subject).

As shown in FIGS. 1A to 2, the top plate 122 has four illumination openings 126 in total, with two in its right portion (one at the front and the other at the rear) and the other two in its left portion (one at the front and the other at the rear). The positions of the illumination openings 126 are not limited to the positions shown in the figure and are determined as appropriate based on the positions of the illuminators 16. The illumination openings 126 may not be four illumination openings 126, but may be three or fewer or five or more illumination openings 126. The number of illumination openings 126 is determined based on the number of illuminators 16 in the imaging device 10.

The rear case 121 is fastened to the front case 120 and closes the bottom (lower portion) of the front case 120. The rear case 121 is fastened to the front case 120 with, for example, screws.

### Connector 25

As shown in FIG. 2, the imaging device 10 includes a connector 25 connectable to, for example, a power cable or a communication cable. More specifically, the imaging device 10 includes a female connector 25 that can receive a universal serial bus (USB) cable. The connector 25 faces an opening in the right side wall plate of the rear case 121 or an opening in the lower surface of the rear case 121. The connector 25 is electrically connected to a substrate 240 including a power supply 24.

### Camera Module 11

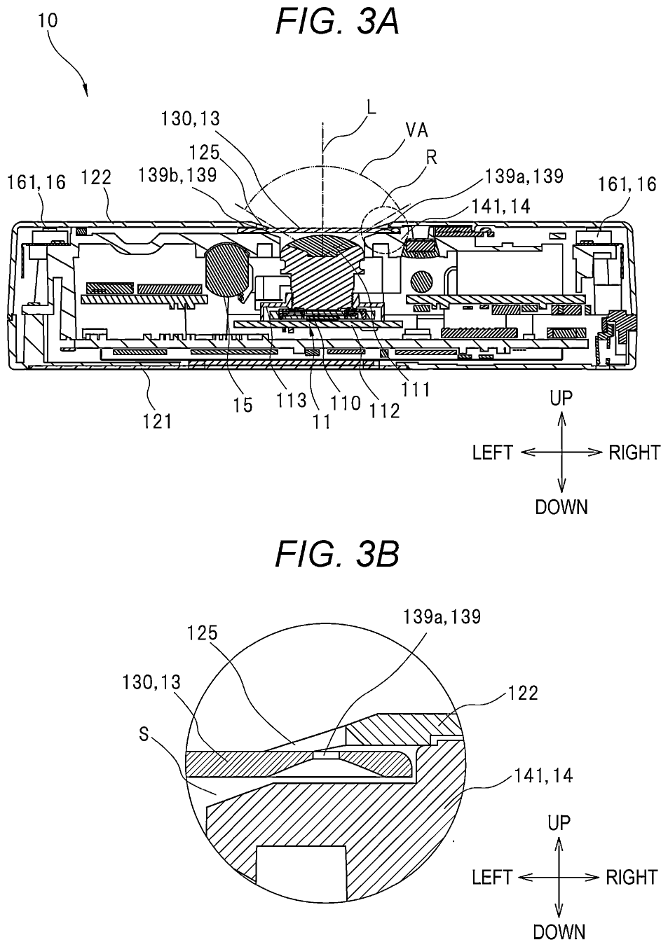

FIG. 3A is a cross-sectional view of the imaging device 10 in the closed state shown in FIG. 1A taken along line A-A. The camera module 11 includes an imaging element (image sensor) 110, such as a complementary metal-oxide-semiconductor (CMOS) or a charge-coupled device (CCD), and the lens 111. The imaging element 110 is mounted on a substrate 112. The lens 111 is, for example, a convex lens, and has a predetermined curvature with its middle portion (an area adjacent to the optical axis L) protruding toward the imaging target (subject). The lens 111 is located above the imaging element 110 and held by a lens holder 113. Below the lens holder 113, the substrate 112 on which the above imaging element 110 is mounted is fastened with, for example, screws.

The lens 111 collects the subject light in a viewing range VA. The viewing range VA is narrower than the first opening 125. Thus, when the imaging device 10 is in the open state, the lens 111 guides and collects the subject light traveling through the first opening 125 and traveling within the viewing range VA to a light-receiving surface of the imaging element 110. In other words, the lens 111 is an optical member (imaging optical system) that forms an image of an imaging target on the light-receiving surface of the imaging element 110, or at least a part of the optical member. The imaging element 110 converts the brightness of light for the image formed by the lens 111 to electric charge and outputs a signal (image signal) corresponding to the resultant electric charge.

### Antenna 27

Referring back to FIG. 2, the imaging device 10 includes the antenna 27 and can be interconnected with other devices through a wireless local area network (LAN), or Wi-Fi. For example, the imaging device 10 can wirelessly transmit signals (image signals) output from the imaging element 110 to other devices such as smartphones and tablet terminals. The imaging device 10 can be remotely controlled with another device such as a smartphone.

### Illuminator 16

The illuminators 16 emit illumination light to illuminate the imaging target when imaging is performed in a dark surrounding environment. Each illuminator 16 includes an illumination light source 161 and a cover 162. The illumination light source 161 is, for example, a light-emitting diode (LED) that emits light with a wavelength in the infrared region (infrared rays or infrared light) under control of the controller 31 (described later). The illumination light source 161 may not emit infrared light as illumination light, and may emit visible light other than infrared light as illumination light. The illumination light source 161 is located on a base 140 included in the blade driver 14 (described later).

The covers 162 are formed from, for example, a light-transmissive resin, and are each located adjacent to an illumination light emission portion of (upward from) the corresponding illumination light source 161. Each cover 162 has a surface covering at least an upper portion of the corresponding illumination light source 161. The surface of the cover 162 is fitted into the corresponding illumination opening 126. In this case, each cover 162 is attached without its surface protruding outward from (or above) the outer surface of the top plate 122 of the housing 12. Illumination light emitted from the illumination light sources 161 is output from the imaging device 10 through the surfaces of the covers 162.

As shown in FIGS. 1A to 2, the imaging device 10 includes four illuminators 16. Of the four illuminators 16, a pair of illuminators 16 are located in the right portion of the top plate 122, with one illuminator 16 located at the front and the other illuminator 16 at the rear. The other pair of illuminators 16 are located in the left portion of the top plate 122, with one illuminator 16 located at the front and the other illuminator 16 at the rear.

The imaging device 10 may not include four illuminators 16. The imaging device 10 may include three or fewer illuminators 16 or five or more illuminators 16.

### Illuminometer 17

The illuminometer 17, which is, for example, a photoresistor or a photodiode, receives light from the surrounding environment (external environment) of the imaging device 10. The illuminometer 17 is located on the base 140 in the blade driver 14 described in detail later. The illuminometer 17 converts the brightness of received light into electric charge and outputs a signal (luminance signal) corresponding to the resultant electric charge. In other words, the illuminometer 17 functions as a detector to detect the brightness of the environment surrounding the imaging device 10.

### Blade 13 and Blade Driver 14

The blade driver 14 includes the base 140 and an actuator 15. The blade driver 14 moves the blade 13 in a direction parallel to a long side of the top plate 122 (first direction) to open and close the first opening 125, and controls subject light that enters the lens 111. More specifically, the blade driver 14 moves the blade 13 between a closed position (first position) at which the first opening 125 is closed and an open position (second position) at which the first opening 125 is open. In other words, the blade 13 moved by the blade driver 14 in the first direction is at the first position to restrict subject light from entering the imaging element 110 or the second position to allow the subject light to enter the imaging element 110. The blade 13 at the first position covers the first opening 125 to function as a light shield for restricting subject light from entering the imaging element 110.

In other words, the blade driver 14 switches the first opening 125 in the imaging device 10 from the closed state (FIG. 1A) to the open state (FIG. 1B). The blade driver 14 switches the first opening 125 in the imaging device 10 from the open state (FIG. 1B) to the closed state (FIG. 1A). Thus, the lens 111 is covered in the closed state (FIG. 1A) and is exposed in the open state (FIG. 1B).

### Base 140

The base 140 is formed from, for example, a synthetic resin, and includes a main base 141 and a sub-base 142 integral with each other. The main base 141 is located adjacent to the top plate 122 of the housing 12 with respect to (upward from) the lens 111. The sub-base 142 extends downward from the main base 141, and has a threaded hole for fastening the sub-base 142 to the rear case 121 with a screw. The sub-base 142 is fastened to the rear case 121 with the screw. This fastens the base 140 to the rear case 121.

The main base 141 has a circular opening 143 vertically extending through the base 140 with the optical axis L of the lens 111 at the center. In other words, the opening 143 is a through-hole in the main base 141. Light (subject light) reflected from the imaging target (subject) travels through the first opening 125 in the housing 12 and enters the lens 111 through the opening 143. The opening 143 has an outer diameter larger than the outer diameter of the lens 111 and smaller than the outer diameter of the first opening 125 in the front case 120.

The main base 141 receives at least the blade 13, the actuator 15, the illuminators 16, and the illuminometer 17. The blade 13, the illuminators 16, and the illuminometer 17 are mounted on the upper surface of the main base 141.

The main base 141 receives two illuminators 16 in its right portion and two illuminators 16 in its left portion. The illuminometer 17 is located on the right of the opening 143 in a central portion in the front-rear direction. A sound collector 20 is located adjacent to (on the left of) the illuminometer 17 with respect to the opening 143. The sound collector 20 includes a microphone for collecting sounds around the imaging device 10. The top plate 122 of the front case 120 has multiple openings (sound collecting openings) 201 for collecting sounds (refer to FIGS. 1A, 1B, and 2). The openings 201 face the sound collector 20. Sounds around the imaging device 10 reach the sound collector 20 through at least one sound collecting opening 201. The illuminometer 17 receives light from the surrounding environment traveling through the sound collecting openings 201. In other words, the illuminometer 17 is located below at least one sound collecting opening 201. For example, a white filter may be located above the illuminometer 17, or more specifically, between the illuminometer 17 and the front case 120. The filter transmits light from the environment surrounding the imaging device 10, allowing the light to reach the illuminometer 17. The filter also reduces dust or other matter entering through the sound collecting openings 201 into the imaging device 10.

The main base 141 includes a substantially rectangular contact member 146 on the left end of its upper surface. The contact member 146 has an upper surface in contact with the lower surface of the blade 13 (described later).

### Actuator 15

The actuator 15 is mounted on (the lower surface of) the main base 141 to be adjacent to the rear case 121. The actuator 15 functions as a drive to move the blade 13 in the first direction as described in detail later. The actuator 15 includes a motor 151, a rotational shaft 152, and a gear 153. The motor 151 includes, for example, components such as a coil, a yoke, and a magnet, and rotates with electric power (current) supplied from the power supply 24 under control performed by the controller 31. The motor 151 reverses the rotation direction in response to the direction of a current supplied to the coil. For example, a current flowing in one direction in the coil causes the motor 151 to rotate clockwise, and a current flowing in the opposite direction causes the motor 151 to rotate counterclockwise.

The rotational shaft 152 extends in the second direction and meshes with the gear 153. The rotational shaft 152 is driven to rotate as the motor 151 rotates. The gear 153 meshing with the rotational shaft 152 rotates as the rotational shaft 152 is driven to rotate. As described above, the motor 151 reverses the rotation direction in response to the direction of a supplied current. The rotational shaft 152 and the gear 153 thus reverse their rotation directions in response to the direction of a current supplied to the motor 151 in the same manner.

### Blade 13

The blade 13 is formed from, for example, a synthetic resin or a metal material. As shown in FIG. 2, the blade 13 is supported in a linearly movable manner (slidably) on the main base 141 of the base 140. With the main base 141 above the lens 111, the blade 13 is located between the first opening 125 in the housing 12 and the lens 111 in the camera module 11. The blade 13 includes a light-shielding surface 130 and a guide 131 frontward from the light-shielding surface 130.

### Light-shielding Surface 130

The light-shielding surface 130 is a thin plate with its longitudinal direction as the first direction. The light-shielding surface 130 is located above the base 140 and overlaps the base 140. More specifically, the light-shielding surface 130 overlaps the main base 141 and partially covers the main base 141.

The light-shielding surface 130 has a second opening 133 and auxiliary openings 139 vertically extending through the light-shielding surface 130. In other words, the second opening 133 and the auxiliary openings 139 are through-holes located in a part of the light-shielding surface 130. The second opening 133 and the auxiliary openings 139 connect the inside and the outside of the light-shielding surface 130. When the blade 13 is at the second position, the second opening 133 allows subject light traveling through the first opening 125 in the top plate 122 to travel through. The second opening 133 is defined by a first open area 133a and a second open area 133b.

The first open area 133a is defined between two first side wall surfaces 130b that face each other and extend leftward in the first direction from the right end of the light-shielding surface 130. The length (width) of the first open area 133a in the second direction (front-rear direction), or in other words, the distance between the first side wall surfaces 130b, is greater than the lengths (widths) of the illuminometer 17 and the sound collector 20 in the second direction.

The second open area 133b is circular or substantially circular. When the imaging device 10 is in the open state, or in other words, the blade 13 is at the open position, the optical axis L of the lens 111 extends through the center of the second open area 133b. More specifically, the second open area 133b is an area surrounded by an arc-shaped second side wall surface 130c connected to the left end of the first side wall surfaces 130b. The second open area 133b has the same or substantially the same outer diameter as the first opening 125 in the top plate 122 of the front case 120.

The light-shielding surface 130 has a lower surface in contact with the upper surface of the contact member 146 on the main base 141 described above. As described above, the contact member 146 is located at the left end of the upper surface of the main base 141. The contact member 146 supports the light-shielding surface 130 of the blade 13 from below at the open position. This reduces rattling of, for example, the blade 13 with its right portion moving vertically on the main base 141.

### Auxiliary Opening 139

The auxiliary openings 139 are elongated holes located rightward and leftward from the optical axis L (refer to FIGS. 1A and 2). More specifically, the auxiliary openings 139 are two auxiliary openings 139a and 139b at different positions in the first direction (lateral direction). More specifically, as shown in FIG. 3A, when the blade 13 is at the closed position (first position), the auxiliary opening 139a overlaps an area adjacent to the right end of the first opening 125 in the top plate 122 of the front case 120 in the vertical direction parallel to the optical axis L. When the blade 13 is at the closed position (first position), the auxiliary opening 139b overlaps an area adjacent to the left end of the first opening 125 in the top plate 122 of the front case 120 in the vertical direction parallel to the optical axis L. More specifically, the auxiliary openings 139 are located outside the viewing range VA of the lens 111 shown in FIG. 3A. The auxiliary openings 139 thus vertically overlap the main base 141 of the base 140 in the blade driver 14.

FIG. 3B is a partially enlarged cross-sectional view of region R surrounded by the dashed line shown in FIG. 3A. As shown in FIG. 3B, the auxiliary opening 139a is flared in the vertical direction to have an inner diameter increasing downward, or toward the main base 141. The auxiliary opening 139b is also flared in the same manner as the auxiliary opening 139a.

The imaging device 10 in the closed state allows some light beams of the subject light traveling outside the viewing range VA of the lens 111 to reach inside the imaging device 10 through the auxiliary openings 139. In other words, the auxiliary openings 139 allow the subject light to travel through. As described above, the flared auxiliary openings 139 allow light beams traveling nonparallel to the optical axis L to reach inside the imaging device 10 through the auxiliary openings 139. In other words, the auxiliary openings 139 allow light beams from outside the imaging device 10 to travel through when the blade 13 is at the first position. The auxiliary openings 139 may not be flared. The auxiliary openings 139 may be in any shape that allows some light beams of the subject light traveling outside the viewing range VA of the lens 111 to reach inside the imaging device 10 through the auxiliary openings 139.

As described above, the auxiliary openings 139 and the main base 141 vertically overlap each other. Thus, the main base 141 reflects light beams traveling through the auxiliary openings 139. The reflected light (diffused light) from the main base 141 is subsequently reflected from the lower surface of the blade 13 and other internal components, travels through space S between the blade 13 and the main base 141, and reaches the light-receiving surface of the imaging element 110 through the lens 111. The diffused light including light beams that have traveled through the auxiliary opening 139a located on the right of the optical axis L reaches a right portion of the light-receiving surface of the imaging element 110. The diffused light including light beams that have traveled through the auxiliary opening 139b located on the left of the optical axis L reaches a left portion of the light-receiving surface of the imaging element 110. In other words, with the blade 13 at the first position (closed position), the imaging element 110 receives the diffused light that has traveled through the auxiliary openings 139 and has reflected from inside the housing 12.

With the auxiliary openings 139 vertically overlapping the main base 141, the lens 111 is unviewable through the auxiliary openings 139 to the user viewing the imaging device 10 in the direction of the optical axis. The light-shielding surface 130 of the blade 13 may have a color similar to the color of an area of the main base 141 as a support that overlaps the auxiliary openings 139 in the vertical direction parallel to the optical axis L. The auxiliary openings 139 in the light-shielding surface 130 are thus less viewable to the user.

### Guide 131

As shown in FIG. 2, the guide 131 extends downward (toward the rear case 121) from the front of the lower surface of the light-shielding surface 130. The guide 131 extends in the first direction that is the longitudinal direction of the light-shielding surface 130. The guide 131 has its middle portion cut out to define a first portion 131a on the right and a second portion 131b on the left of the lower end of the guide 131. In other words, the lower ends of the first portion 131a and the second portion 131b protrude more downward than the middle portion of the guide 131. The guide 131 includes a rack extending along its rear surface in the first direction. The rack meshes with the gear 153 in the actuator 15 described above. The rotational force of the motor 151 in the actuator 15 is thus transmitted to the blade 13.

### Controller 31

As shown in FIG. 2, the controller 31 is mounted on a substrate 310 located in a front portion of the housing 12. The controller 31 includes, for example, a central processing unit (CPU), a memory, and other components, and is electrically connected to the substrate 112 on which the imaging element 110 is mounted. The controller 31 is a processor that reads and executes a control program prestored in a storage medium, such as a flash memory, to control various components of the imaging device 10. As described in detail later, the controller 31 performs control to switch the imaging device 10 in the closed state to the open state in response to a change in the output from the imaging element 110. The controller 31 also controls driving of the actuator 15 to move the blade 13.

### Position Sensor 138

As shown in FIG. 2, the position sensor 138 is located in a front portion of the housing 12 and inward from the blade 13 described later (or in other words, adjacent to the imaging element 110). The position sensor 138 includes a contact portion 138a that is a rod extending vertically. As the blade 13 moves, the contact portion 138a comes in contact with the guide 131 included in the blade 13 and tilts rightward or leftward. More specifically, when the blade 13 moves from the closed position (right) to the open position (left), the contact portion 138a comes in contact with the left side surface of the first portion 131a of the guide 131 and tilts leftward. The contact portion 138a then comes in contact with an internal first switch, causing the position sensor 138 to output, to the controller 31, a signal (first signal) indicating that the blade 13 is at the open position.

When the blade 13 moves from the open position (left) to the closed position (right), the contact portion 138a comes in contact with the right side surface of the second portion 131b of the guide 131 and tilts rightward. The contact portion 138a then comes in contact with an internal second switch, causing the position sensor 138 to output, to the controller 31, a signal (second signal) indicating that the blade 13 is at the closed position.

### Process Performed by Controller 31

To set the imaging device 10 to the open or closed state, the controller 31 performs a process (gesture detection process) for detecting whether a predetermined gesture has been performed by the user on the imaging device 10 in the closed state, and a process (blade moving process) for moving the blade 13 in the first direction. Each of the above processes will now be described.

### Gesture Detection Process

When the imaging device 10 is in the closed state, or in other words, when the second signal is received from the position sensor 138, the controller 31 uses a signal (image signal) output from the imaging element 110 to determine whether the predetermined gesture has been performed by the user on the imaging device 10. As described above, when the blade 13 is at the closed position, light beams traveling outside the viewing range VA of the lens 111 enter the housing 12 through the auxiliary openings 139 and reach the light-receiving surface of the imaging element 110. The light beams entering the housing 12 are reflected from the internal structure of the imaging device 10. The reflected light beams as diffused light then reach the light-receiving surface of the imaging element 110 through the lens 111. In other words, the diffused light reaching the imaging element 110 when the imaging device 10 is in the closed state does not form an image on the light-receiving surface of the imaging element 110.

Thus, the image signal output from the imaging element 110 has an output value corresponding to the amount (brightness) of diffused light entering through the auxiliary openings 139. As described above, the diffused light entering through the auxiliary opening 139a is incident on the right portion of the light-receiving surface of the imaging element 110, and the diffused light entering through the auxiliary opening 139b is incident on the left portion of the light-receiving surface of the imaging element 110. When a right portion of the imaging device 10 is shadowed by, for example, another object, the output from a right portion of the imaging element 110 (the area adjacent to a first end in the first direction) decreases. When a left portion of the imaging device 10 is shadowed by, for example, another object, the output from a left portion of the imaging element 110 (the area adjacent to a second end in the first direction) decreases.

The controller 31 uses the image signal to determine whether the predetermined gesture has been performed by the user. More specifically, the controller 31 determines, when the blade 13 is at the closed position (first position), whether the predetermined gesture has been performed based on a change in the output from the imaging element 110 that has received the diffused light, which has traveled through the auxiliary opening 139a and reflected inside the housing 12. Upon detecting the predetermined gesture, the controller 31 moves the blade 13 from the first position to the second position. Examples of the predetermined gesture performed by the user include waving a hand a predetermined number of times in the lateral direction (first direction) in front of the imaging device 10.

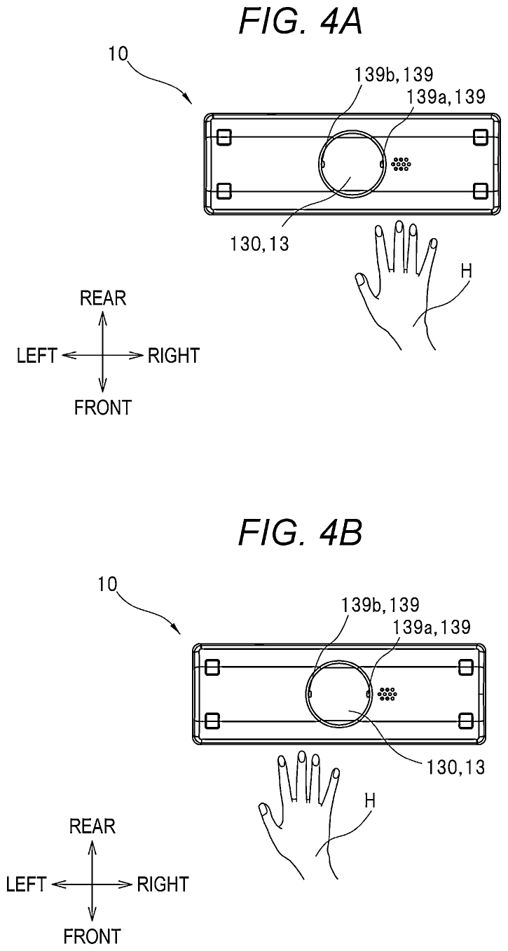

FIGS. 4A and 4B are diagrams each describing an example predetermined gesture performed by the user. FIG. 4A is a schematic diagram of a hand H of the user placed on the right of the imaging device 10. FIG. 4B is a schematic diagram of the hand H of the user placed on the left of the imaging device 10. When the user waves the hand H, the state in FIG. 4A and the state in FIG. 4B are alternately repeated a predetermined number of times.

When the hand H is placed on the right of the imaging device 10, as shown in FIG. 4A, the output from the area adjacent to the first end in the first direction of the imaging element 110 decreases. When the hand H is placed on the left of the imaging device 10, as shown in FIG. 4B, the output from the area adjacent to the second end in the first direction of the imaging element 110 decreases. When the user waves the hand H, the output from the area adjacent to the first end in the first direction of the imaging element 110 decreases and the output from the area adjacent to the second end in the first direction of the imaging element 110 decreases the predetermined number of times during a period (gesture period) in which the user is performing the predetermined gesture.

The controller 31 determines, based on the received image signal, that the user has performed the predetermined gesture by detecting a change in the output from the imaging element 110 in response to the predetermined gesture in the first direction performed by the user during the gesture period. Upon detecting the predetermined gesture performed by the user, the controller 31 drives the actuator 15 to move the blade 13 from the closed position (first position) to the open position (second position).

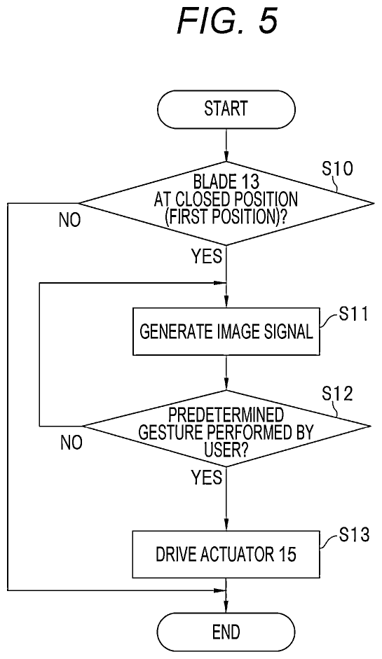

FIG. 5 is a flowchart of the gesture detection process performed by the controller 31. The controller 31 reads and executes a program recorded in, for example, an internal memory to perform the processing in the flowchart in FIG. 5.

In step S10, the controller 31 determines whether the blade 13 is at the closed position (first position). More specifically, the controller 31 determines whether the second signal has been output from the position sensor 138. When the second signal has yet to be output, the controller 31 yields a negative determination result in step S10, and ends the processing. Upon receiving the second signal, the controller 31 yields an affirmative determination result in step S10, and the processing advances to step S11.

In step S11, the controller 31 controls and causes the imaging element 110 to generate an image signal at a predetermined frame rate and to output the generated image signal to the controller 31. The processing then advances to step S12.

In step S12, the controller 31 determines whether the user has performed the predetermined gesture based on the image signal generated for each predetermined frame rate during the gesture period. In this case, the controller 31 determines, based on multiple image signals output during the gesture period, whether the outputs from the areas adjacent to the first end and the second end in the first direction of the imaging element 110 corresponding to positions on the right and left of the imaging device 10 have changed. When the outputs from the areas adjacent to the first end and the second end in the first direction have changed the predetermined number of times, the controller 31 determines that the user has performed the predetermined gesture and yields an affirmative determination result. The processing then advances to step S13. When the outputs from the areas adjacent to the first end and the second end in the first direction of the imaging element 110 have not changed or when the outputs have not changed the predetermined number of times, the controller 31 determines, based on multiple image signals, that the user has yet to perform the predetermined gesture and yields a negative determination result. The processing then returns to step S11.

In step S13, the controller 31 drives the actuator 15 and ends the processing. This moves the blade 13 to the open position (second position) as described later.

### Blade Moving Process

As described above, when the imaging device 10 is in the closed state, the controller 31 detecting the predetermined gesture performed by the user moves the blade 13 leftward to switch the imaging device 10 to the open state. More specifically, the controller 31 controls the direction of a current supplied to the coil in the actuator 15 to rotate the motor 151. The rotation of the motor 151 generates a driving force, which is transmitted to the light-shielding surface 130 through the gear 153. As described above, the gear 153 meshes with the rack extending in the first direction on the guide 131 in the blade 13. Thus, the driving force resulting from the rotation of the motor 151 is converted to a force for linear movement in the first direction.

This moves the light-shielding surface 130 leftward in the lateral direction. When the light-shielding surface 130 moves leftward and reaches the open position, the contact portion 138a comes in contact with the internal first switch, and the position sensor 138 outputs the first signal to the controller 31. Upon receiving the first signal, the controller 31 stops supplying a current to the coil in the actuator 15 and stops moving the blade 13.

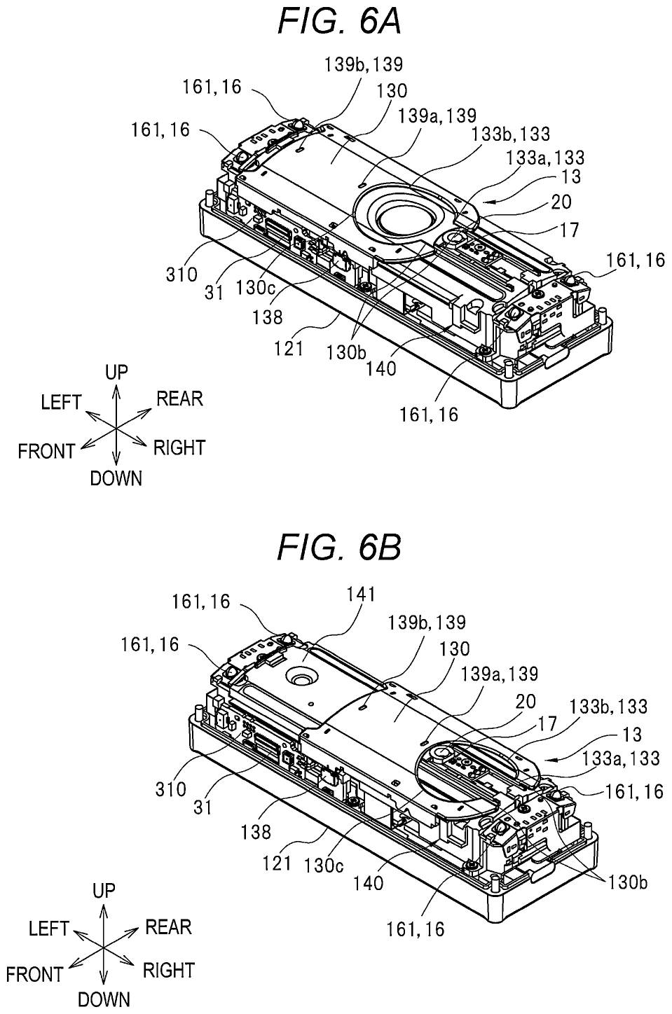

FIG. 6A is an internal perspective view of the imaging device 10 in the open state as in FIG. 1B with the front case 120 removed.

As shown in FIG. 6A, the blade 13 is movable leftward to a position at which the first opening 125 is open. More specifically, the blade 13 is movable to a position at which the center of the second open area 133b of the second opening 133 in the blade 13 aligns or substantially aligns with the center of the first opening 125 in the top plate 122. This exposes the lens 111 as shown in FIG. 1B. As described above, the opening 143 in the main base 141 of the base 140 has an outer diameter larger than the outer diameter of the lens 111 and smaller than the outer diameter of the first opening 125 in the front case 120. Thus, the main base 141 is also partially exposed (refer to FIG. 1B) after the blade 13 moves to the open position. With the partially exposed main base 141 and the second side wall surface 130c of the second open area 133b of the light-shielding surface 130 between the main base 141 and the top plate 122, the imaging device 10 is disconnected from outside. This structure reduces foreign matter such as dust entering through the first opening 125 into the housing 12.

As shown in FIG. 6A, when the blade 13 is at the open position, the sound collector 20 is partially located in the first open area 133a of the second opening 133, and the other portion of the sound collector 20 and the illuminometer 17 are located rightward from the light-shielding surface 130 of the blade 13. In other words, the illuminometer 17 and the sound collector 20 are not covered with the light-shielding surface 130.

When the imaging device 10 is in the open state, the controller 31 receiving a signal instructing to move the blade 13 to the closed position through, for example, the antenna 27 moves the blade 13 rightward to switch the imaging device 10 to the closed state. More specifically, the controller 31 controls, when switching the imaging device 10 to the open state, the direction of a current supplied to the coil in the actuator 15 to the reverse direction to reversely rotate the motor 151. The driving force resulting from the reverse rotation of the motor 151 moves the light-shielding surface 130 rightward in the lateral direction. When the light-shielding surface 130 moves rightward and reaches the closed position, the contact portion 138a comes in contact with the internal second switch, and the position sensor 138 outputs the second signal to the controller 31. Upon receiving the second signal, the controller 31 stops supplying a current to the coil in the actuator 15 and stops moving the blade 13.

FIG. 6B is an internal perspective view of the imaging device 10 in the closed state as in FIG. 1A with the front case 120 removed.

As shown in FIG. 6B, the blade 13 is movable rightward to a position at which the first opening 125 is fully covered. In other words, the blade 13 is movable to a position at which the left end of the second open area 133b of the second opening 133 in the blade 13 is located rightward from the right end of the first opening 125. At this position, the illuminometer 17 and the sound collector 20 are in the second open area 133b of the second opening 133.

When the blade 13 moves between the open position and the closed position, the first open area 133a of the second opening 133 described above passes over positions to receive the illuminometer 17 and the sound collector 20. In other words, the illuminometer 17 and the sound collector 20 are not covered with the light-shielding surface 130. Thus, the illuminometer 17 and the sound collector 20 are not covered with the blade 13 independently of whether the blade 13 is at the open position or the closed position or is moving between the open position and the closed position. Thus, the illuminometer 17 maintains, independently of the position of the blade 13, its function to detect the brightness of the surrounding environment, and the sound collector 20 maintains, independently of the position of the blade 13, its function to collect the surrounding sounds.

The structure according to the first embodiment described above produces at least one of the advantageous effects described below.

(1) The imaging device 10 includes the auxiliary openings 139 outside the viewing range of the lens 111 to allow subject light to travel through. When the blade 13 is at the closed position as the first position, the controller 31 controls the actuator 15 as a drive to move the blade 13 to the open position as the second position based on a change in the output from the imaging element 110 receiving diffused light traveling through the auxiliary openings 139 and reflected from inside the housing 12. This structure allows control of the blade 13 to move to the open position without a device that inputs an instruction (trigger) for moving the blade 13 to the open position from outside the imaging device 10 or without a sensor that detects a change in the surrounding environment outside the imaging device 10. This reduces the likelihood of the internal structure of the imaging device 10 being complicated and of increasing the number of components, thus reducing the manufacturing cost. When the blade 13 moves to the closed position, the lens 111 is externally unviewable. This protects the privacy of a person being imaged.

(2) The auxiliary openings 139 are located in the light-shielding surface 130 of the blade 13. This structure can guide the light from outside the imaging device 10 to the imaging element 110 when the blade 13 is at the closed position.

(3) The blade 13 includes multiple auxiliary openings 139 at different positions in the lateral direction as the first direction. When the output from the imaging element 110 changes in response to the predetermined gesture in the first direction performed by the user, the controller 31 controls the actuator 15 to move the blade 13 to the open position as the second position. This allows the blade 13 to move to the open position with a simple operation and the imaging device 10 to switch to the open state in which images can be captured.

### Second Embodiment

An imaging device according to a second embodiment will be described below. In the example described below, like reference numerals denote like components in the first embodiment, and the second embodiment will be described focusing on the differences from the first embodiment. Unless otherwise specified, the components are the same as in the first embodiment. The imaging device according to the second embodiment differs from the imaging device 10 according to the first embodiment in the auxiliary openings and in an environmental change detection process that uses the orientation of the imaging device installed.

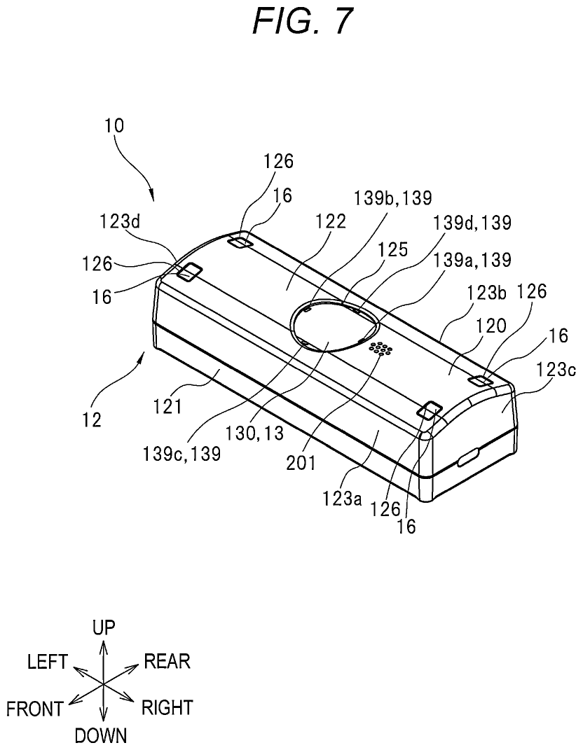

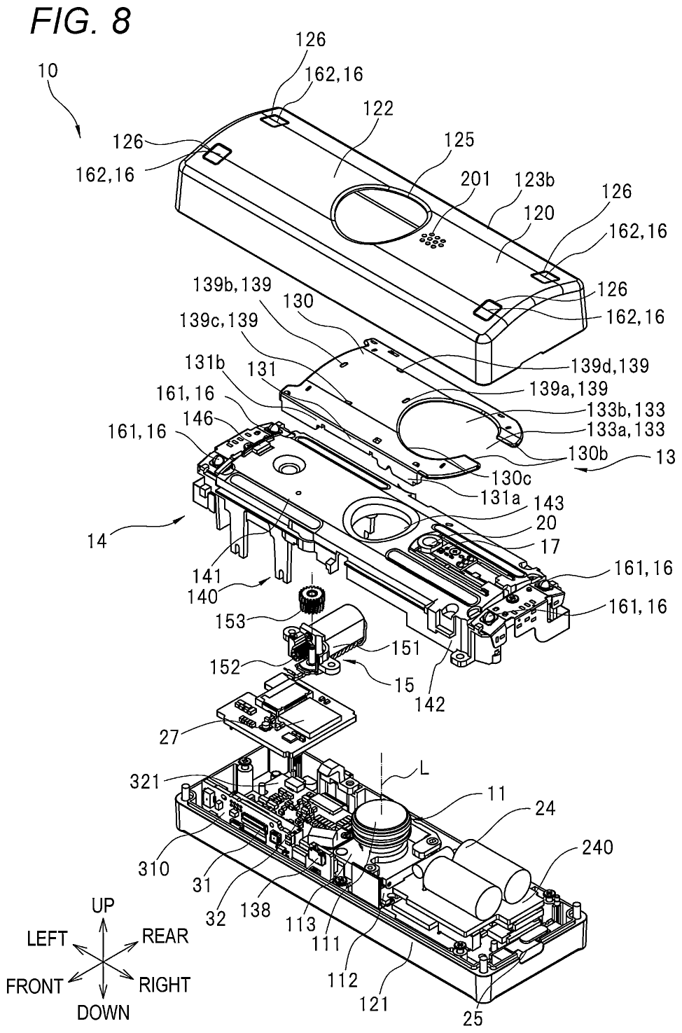

FIG. 7 is an external view of the imaging device 10 according to the second embodiment in the closed state. FIG. 8 is an exploded perspective view of the imaging device 10 according to the second embodiment. In the second embodiment, the auxiliary openings 139 in the light-shielding surface 130 of the blade 13 include, in addition to the auxiliary openings 139a and 139b as in the first embodiment, auxiliary openings 139c and 139d. As shown in FIG. 8, the imaging device 10 further includes an orientation detector 32.

### Auxiliary Opening 139

In the second embodiment, the auxiliary openings 139 further include the two auxiliary openings 139c and 139d in the second direction (front-rear direction) intersecting with the first direction. The auxiliary opening 139c is an elongated hole located frontward from the optical axis L. The auxiliary opening 139d is an elongated hole located rearward from the optical axis L. When the blade 13 is at the closed position (first position), the auxiliary opening 139c overlaps an area adjacent to the front end of the first opening 125 in the top plate 122 of the front case 120 in the vertical direction parallel to the optical axis L. When the blade 13 is at the closed position (first position), the auxiliary opening 139d overlaps an area adjacent to the rear end of the first opening 125 in the top plate 122 of the front case 120 in the vertical direction parallel to the optical axis L. More specifically, the auxiliary openings 139c and 139d are also outside the viewing range VA of the lens 111 shown in FIG. 3A.

The auxiliary openings 139c and 139d at the above positions, similarly to the auxiliary openings 139a and 139b, vertically overlap the main base 141 of the base 140 in the blade driver 14. The auxiliary openings 139c and 139d are flared (refer to FIG. 3B) in the vertical direction to each have an inner diameter increasing downward, or toward the main base 141, similarly to the auxiliary openings 139a and 139b.

Light beams traveling through the auxiliary opening 139c are reflected from components of the imaging device 10 such as the main base 141. The reflected light beams as diffused light then reach a front portion of the light-receiving surface of the imaging element 110. Light beams traveling through the auxiliary opening 139d are reflected from other components of the imaging device 10 such as the main base 141. The reflected light beams as diffused light then reach a rear portion of the light-receiving surface of the imaging element 110. When a front portion of the imaging device 10 is blocked by, for example, another object, the output from an area (the area adjacent to the first end in the second direction) of the imaging element 110 corresponding to the front portion of the imaging device 10 changes. When a rear portion of the imaging device 10 is blocked by, for example, another object, the output from an area (the area adjacent to the second end in the second direction) of the imaging element 110 corresponding to the rear portion of the imaging device 10 changes.

### Orientation Detector 32

The orientation detector 32 is, for example, an acceleration sensor located on a substrate 321. The orientation detector 32 detects the orientation of the imaging device 10 based on gravity acting on the imaging device 10, and outputs a signal (orientation signal) to the controller 31. The controller 31 determines the orientation of the installed imaging device 10 based on the received orientation signal. More specifically, the controller 31 determines, based on the orientation signal, whether the imaging device 10 is installed in an orientation (first orientation) in which the lateral direction (first direction) intersects with the vertical direction (gravity direction) or whether the imaging device 10 is installed in an orientation (second orientation) in which the first direction is parallel to the vertical direction (gravity direction). The controller 31 may determine that the imaging device 10 is installed in the first orientation when the front-rear direction (second direction) of the imaging device 10 is parallel to the vertical direction, and that the imaging device 10 is installed in the second orientation when the lateral direction (first direction) of the imaging device 10 is parallel to the vertical direction. In other words, when the orientation detector 32 detects gravity acting on the front portion or the rear portion of the imaging device 10, the controller 31 determines that the imaging device 10 is installed in the first orientation. When the orientation detector 32 detects gravity acting on the right portion or the left portion of the imaging device 10, the controller 31 determines that the imaging device 10 is installed in the second orientation.

### Gesture Detection Process

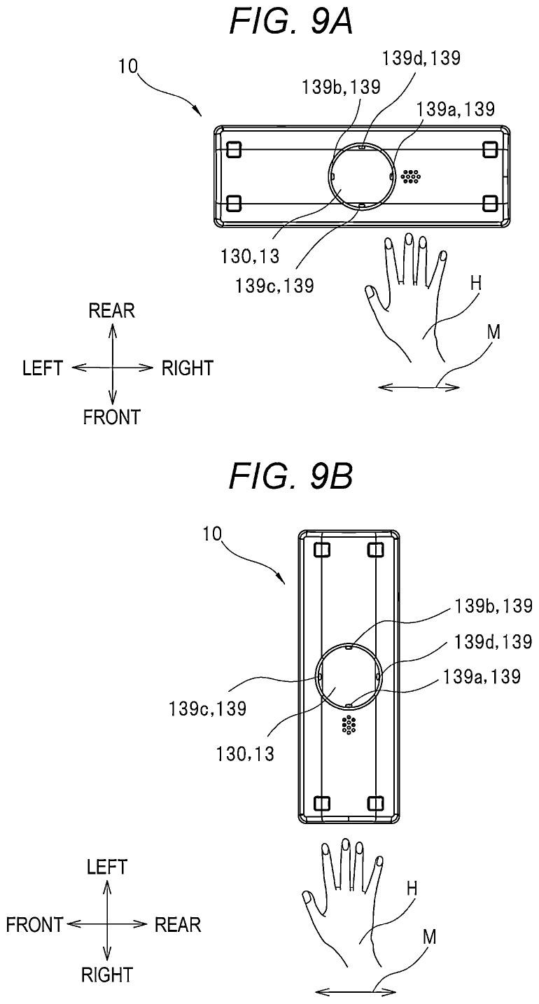

In the second embodiment as well, the controller 31 performs the gesture detection process when the imaging device 10 is in the closed state. FIG. 9A is a schematic diagram of the imaging device 10 installed in the first orientation, describing the predetermined gesture performed by the user. FIG. 9B is a schematic diagram of the imaging device 10 installed in the second orientation, describing the predetermined gesture performed by the user. FIG. 9A shows the imaging device 10 installed with its front portion facing downward in the vertical direction. FIG. 9B shows the imaging device 10 installed with its right portion facing downward in the vertical direction.

The predetermined gesture performed by the user is waving the hand H, as in the first embodiment. In this case, as shown in FIGS. 9A and 9B, the user moves the hand H back and forth a predetermined number of times in the direction (gesture direction) M intersecting with the vertical direction.

When the imaging device 10 is installed in the first orientation as shown in FIG. 9A, the first direction of the imaging device 10 intersects with the direction of gravity acting on the imaging device 10. In this state, the lateral direction of the imaging device 10, or more specifically, the first direction in which the blade 13 moves, aligns with or substantially aligns with the gesture direction M of the user.

In this case, the controller 31 determines, as in the first embodiment, whether the predetermined gesture has been performed by the user based on a change in the output from the imaging element 110. In other words, the controller 31 determines that the predetermined gesture has been performed by the user when detecting, based on the image signal, that the output from the area adjacent to the first end in the first direction of the imaging element 110 has decreased, and the output from the area adjacent to the second end in the first direction of the imaging element 110 has decreased the predetermined number of times. In other words, when the first direction of the imaging device 10 intersects with the gravity direction, the controller 31 determines whether the predetermined gesture has been performed by the user based on a change in the output from the imaging element 110 corresponding to the light beams traveling through the auxiliary openings 139a and 139b located in the first direction.

When the imaging device 10 is installed in the second orientation as shown in FIG. 9B, the second direction of the imaging device 10 intersects with the direction of gravity acting on the imaging device 10, and the first direction of the imaging device 10 intersects with the gesture direction M. In this state, the front-rear direction of the imaging device 10, or more specifically, the second direction intersecting with the first direction in which the blade 13 moves, aligns with or substantially aligns with the gesture direction M of the user.

In this case, the controller 31 determines whether the predetermined gesture has been performed by the user based on a change in the output from the imaging element 110. In other words, the controller 31 determines that the predetermined gesture has been performed by the user when detecting, based on the image signal, that the output from the area adjacent to the first end in the second direction of the imaging element 110 has decreased, and the output from the area adjacent to the second end in the second direction of the imaging element 110 has decreased the predetermined number of times. In other words, when the second direction of the imaging device 10 intersects with the gravity direction, the controller 31 determines whether the predetermined gesture has been performed by the user based on a change in the output from the imaging element 110 corresponding to the light beams traveling through the auxiliary openings 139c and 139d located in the second direction.

Upon determining that the predetermined gesture in the gesture direction M has been performed by the user, the controller 31 drives the actuator 15 to move the blade 13 from the closed position to the open position as in the first embodiment.

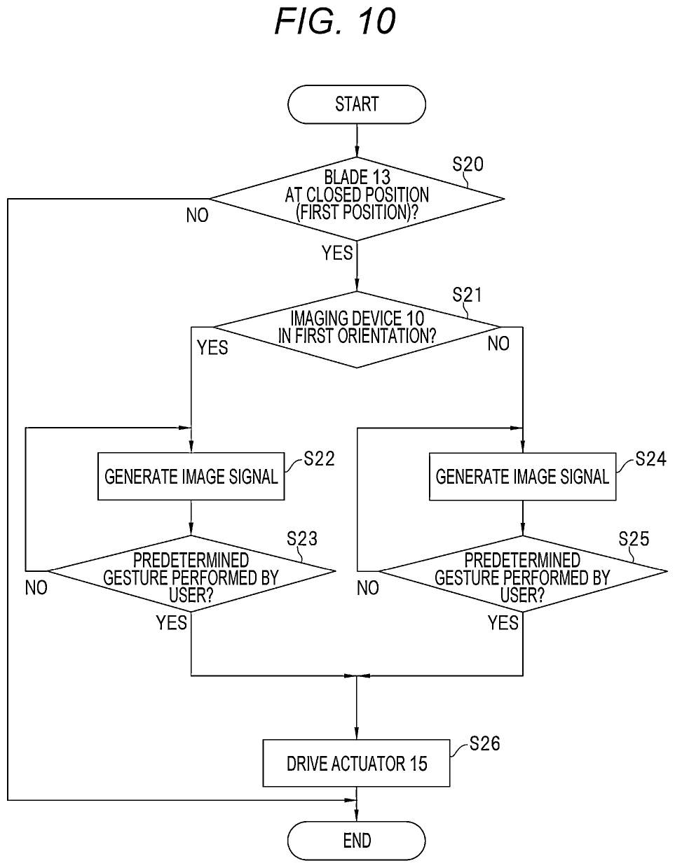

FIG. 10 is a flowchart of the gesture detection process performed by the controller 31 in the second embodiment. The controller 31 reads and executes a program recorded in, for example, an internal memory to perform the processing in the flowchart in FIG. 10.

In step S20 (determination as to whether the blade 13 is at the closed position), the controller 31 performs the same processing as in step S10 (determination as to whether the blade 13 is at the closed position) shown in FIG. 5. The processing then advances to step S21. In step S21, the controller 31 determines, based on the orientation signal output from the orientation detector 32, whether the imaging device 10 is installed in the first orientation. When the first direction of the imaging device 10 intersects with the direction of gravity acting on the imaging device 10, the controller 31 determines that the imaging device 10 is in the first orientation and yields an affirmative determination result. The processing then advances to step S22. When the first direction of the imaging device 10 is in the direction of gravity acting on the imaging device 10, the controller 31 determines that the imaging device 10 is in the second orientation and yields a negative determination result. The processing then advances to step S24.

In step S22 (generation of image signal) and step S23 (determination as to whether the predetermined gesture has been performed), the controller 31 performs the same processing as in step S11 (generation of image signal) and step S12 (determination as to whether the predetermined gesture has been performed) shown in FIG. 5. The processing then advances to step S26. In step S24, the controller 31 performs the same processing as in step S11 (generation of image signal) shown in FIG. 5. The processing then advances to step S25.

In step S25, the controller 31 determines whether the predetermined gesture has been performed by the user on the imaging device 10 installed in the second orientation. In this case, the controller 31 determines, based on multiple image signals generated during the gesture period, whether the outputs from the areas adjacent to the first end and the second end in the second direction of the imaging element 110 have changed. When the outputs from the areas adjacent to the first end and the second end in the second direction have changed the predetermined number of times, the controller 31 determines that the user has performed the predetermined gesture and yields an affirmative determination result. The processing then advances to step S26. When the outputs from the areas adjacent to the first end and the second end in the second direction of the imaging element 110 have not changed or when the outputs have not changed the predetermined number of times, the controller 31 determines that the user has yet to perform the predetermined gesture, and yields a negative determination result. The processing then returns to step S24. In step S26 (driving of the actuator 15), the controller 31 performs the same processing as in step S13 (driving of the actuator 15) shown in FIG. 5.

The second embodiment described above produces at least one of the advantageous effects described below, in addition to the advantageous effects (1) and (2) described in the first embodiment.

(4) The imaging device 10 further includes the multiple auxiliary openings 139c and 139d located in the front-rear direction as the second direction intersecting with the first direction. This structure allows guiding of the diffused light toward the imaging element 110 when the predetermined gesture has been performed by the user in a direction different from the first direction in which the blade 13 moves.

(5) When the orientation detected by the orientation detector 32 is the first orientation, the controller 31 controls the actuator 15 as the drive to move the blade 13 to the open position as the second position based on a change in the output from the imaging element 110 in the first direction. When the orientation detected by the orientation detector 32 is the second orientation, the controller 31 controls the actuator 15 as the drive to move the blade 13 to the open position as the second position based on a change in the output from the imaging element 110 in the second direction. This allows control of the blade 13 to move to the open position by determining whether the predetermined gesture has been performed by the user, independently of the orientation of the imaging device 10 installed.

### First Modification

Although the auxiliary openings 139 (139a and 139b) are located in the light-shielding surface 130 of the blade 13 in the first embodiment, the auxiliary openings 139 may be located in a surface other than the light-shielding surface 130.

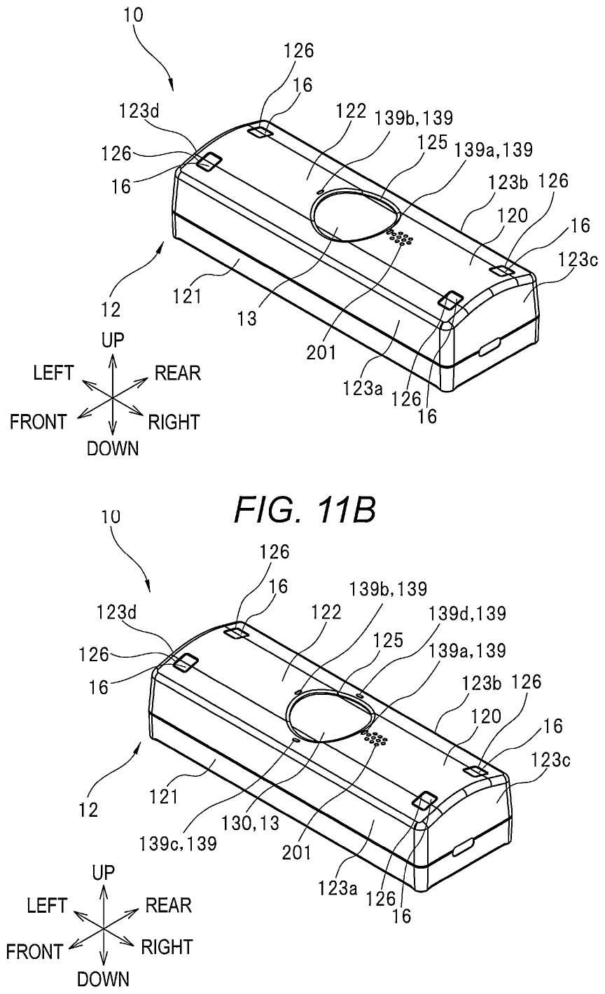

FIG. 11A is an external perspective view of the imaging device 10 according to a first modification in a closed state. As shown in FIG. 11A, the auxiliary openings 139 are located in the top plate 122 of the housing 12, instead of being located in the light-shielding surface 130. More specifically, the auxiliary opening 139a is an elongated hole located rightward from the first opening 125 in the top plate 122, and the auxiliary opening 139b is an elongated hole located leftward from the first opening 125. The auxiliary openings 139a and 139b are located in the top plate 122 outward from the first opening 125. Thus, the auxiliary openings 139 is located outside the viewing range VA of the lens 111 in the first modification as well. Other components of the imaging device 10 according to the first modification and the processing performed by the controller 31 are the same as in the first embodiment.

The structure in the first modification with the auxiliary openings 139 located in the housing 12 also produces the same advantageous effects as the advantageous effects (1) and (3) produced in the first embodiment.

### Second Modification

Although the auxiliary openings 139 (139a, 139b, 139c, and 139d) are located in the light-shielding surface 130 of the blade 13 in the second embodiment, the auxiliary openings 139 may be located in a surface other than the light-shielding surface 130.

FIG. 11B is an external perspective view of the imaging device 10 according to a second modification in a closed state. In the second modification as well, the auxiliary openings 139 are located in the top plate 122 of the housing 12, instead of being located in the light-shielding surface 130. More specifically, each of the auxiliary openings 139a and 139b is at the same position as in the first modification shown in FIG. 11A. The auxiliary opening 139c is an elongated hole located frontward from the first opening 125 in the top plate 122, and the auxiliary opening 139d is an elongated hole located rearward from the first opening 125.

In the second modification as well, the auxiliary openings 139 are located in the top plate 122 outward from the first opening 125. Thus, the auxiliary openings 139 is located outside the viewing range VA of the lens 111. Other components of the imaging device 10 according to the second modification and the processing performed by the controller 31 are the same as in the second embodiment.

The structure in the second modification with the auxiliary openings 139 located in the housing 12 also produces the same advantageous effects as the advantageous effect (1) produced in the first embodiment and the advantageous effects (4) and (5) produced in the second embodiment.

Although various embodiments and modifications are described above, the present invention is not limited to the embodiments and the modifications. Other forms implementable within the scope of technical idea of the present invention fall within the scope of the present invention.

The auxiliary openings 139 in the first and second embodiments and the first and second modifications may not be elongated, and may have other shapes including a circle, an oval, and a polygon.

In the first and second embodiments and the first and the second modifications, the top plate 122 of the housing 12, the main base 141 of the base 140, and the light-shielding surface 130 of the blade 13 in the imaging device 10 are curved in the second direction corresponding to the curvature of the lens 111. In other words, the imaging device 10 in the above examples protrudes upward around its middle portion in the second direction. However, the top plate 122, the main base 141, and the light-shielding surface 130 may have any shape other than the above shape, or may be flat without any protruding portion.

The orientation detector 32 is not limited to an acceleration sensor. For example, the orientation detector 32 may detect the orientation of the imaging device 10 based on the corner speed of the housing 12 obtained using a gyro sensor.

What is claimed is:

1. An imaging device, comprising:
an imaging element configured to receive subject light;
an optical member configured to guide the subject light traveling through a first opening in a housing to the imaging element;
a light shield between the first opening and the optical member, the light shield being at a first position to restrict the subject light from entering the imaging element or at a second position to allow the subject light to enter the imaging element;
a drive configured to move the light shield in a first direction intersecting with an optical axis of the optical member to cause the light shield to be at the first position or at the second position;
an auxiliary opening outside a viewing range of the optical member to allow the subject light to travel through; and
a controller configured to control driving of the drive to move the light shield at the first position to the second position based on a change in an output from the imaging element receiving diffused light traveling through the auxiliary opening and reflected from inside the housing when the light shield is at the first position.

2. The imaging device according to claim 1, wherein the auxiliary opening is located in the light shield.

3. The imaging device according to claim 1, wherein
the auxiliary opening is located in the housing.

4. The imaging device according to claim 2, wherein
the imaging device includes a plurality of the auxiliary openings at different positions in the first direction.

5. The imaging device according to claim 4, wherein
the controller controls the drive to move the light shield at the first position to the second position when the output from the imaging element changes in response to a predetermined gesture in the first direction performed by a user.

6. The imaging device according to claim 4, wherein
the imaging device further includes a plurality of the auxiliary openings located in a second direction intersecting with the first direction.

7. The imaging device according to claim 6, further comprising:
an orientation detector configured to detect an orientation of the imaging device,
wherein the controller moves, based on a change in an output from the imaging element in the first direction, the light shield at the first position to the second position when an orientation detected by the orientation detector is a first orientation in which the first direction intersects with a gravity direction, and
the controller moves, based on a change in an output from the imaging element in the second direction, the light shield at the first position to the second position when an orientation detected by the orientation detector is a second orientation in which the first direction is parallel to the gravity direction.
